(19) United States
(12) Patent Application Publication
(10) Pub. No.: US 2004/0263986 A1
(43) Pub. Date: Dec. 30, 2004

(54) Method and device for combining and shaping beams

(76) Inventor: Daniel M. Brown, Madison, AL (US)

Correspondence Address: KCO LAW P.L.L.C., /DBA KEADY, OLDS & MAIER, PLLC, 128 NORTH PITT STREET, 2ND FLOOR, ALEXANDRIA, VA, 22314, US

(21) Appl. No.: 10/860,124

(22) Filed: Jun. 4, 2004

Related U.S. Application Data
(63) Continuation-in-part of application No. 10/673,630, filed on Sep. 30, 2003.
(60) Provisional application No. 60/414,328, filed on Sep. 30, 2002.

(51) Int. Cl. G02B 27/10; G02B 27/14

(52) U.S. Cl. 359/626

(57) ABSTRACT

An optical device and method is provided for shaping light beams (e.g. emitted from laser diodes) into various shapes and profiles using lenses with different fast and slow axis to combine the light beams generated from at least one light source (e.g. laser diodes).

### CROSS-REFERENCE TO RELATED APPLICATIONS

This application is a continuation-in-part of U.S. patent application Ser. No. 10/673,630 filed on Sep. 30,2003, which claims priority under 35 U.S.C. § 119 (e) on Provisional Application No. 60/414,328, filed on Sep. 30,2002. The disclosures of which are incorporated herein by reference in their entirety.

### FIELD OF THE INVENTION

The present invention relates to a method, apparatus, and system for the shaping and forming of laser beams. More particularly it relates to the shaping and forming of laser beams from laser diodes.

### BACKGROUND OF THE INVENTION

Since the advent of lasers, the usefulness of lasers often depends on the shape of the laser's profile. Various combinations of lenses and other optical devices have been used to shape and manipulate the laser profiles to obtain useful profile characteristics.

One area of interest is the beam combining and shaping of laser profiles from laser diodes. The advantage to using laser diodes is that they are small, provide lightweight optics, can be used in military and/or harsh environments and have long storage lives. In addition laser diodes provide low cost reliable configurations if the profiles of the emitted laser beams can be shaped and/or combined to desired specifications.

One problem currently plaguing the shaping of laser beam profiles, in particular the shaping the light emitted from laser diodes or laser diode bars, is shaping the elliptical profiles in circular profiles and imaging a single dimension diode bar laser profile into a two dimensional laser profile.

### SUMMARY OF THE INVENTION

Exemplary embodiments provide small, lightweight optics affecting light creating improved cross-sectional illumination.

Likewise further exemplary embodiments can beam combine and beam shape laser diodes and laser diode bars.

Exemplary embodiments provide methods and techniques for imaging a single diode bar into a two dimensional diode bar.

Further exemplary embodiments provide a method for reducing the divergence of a laser diode bar to make it appear as a smaller source.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Embodiments of present invention will become more fully understood from the detailed description and the accompanying drawings, wherein:

FIG. 1 shows a single laser diode where the far field profile of the single diode laser beam is shaped by fast axis and slow axis lenses in accordance with at least one exemplary embodiment;

FIG. 2 shows a laser diode bar array, where the far field profile of the bar diode laser beam is shaped by fast axis and slow axis lenses in accordance with at least one exemplary embodiment;

FIG. 3 shows a laser diode bar array using multiple lens arrays, at least one of which is a diffractive lens array, to vary the far field profile of an incident beam(s) to a desired shape in accordance with at least one exemplary embodiment; and

FIG. 4 shows the transformation of an initial 1-D profile from a bar diode laser to a different dimension or spread into a two-dimensional profile in accordance with at least one exemplary embodiment.

### DETAILED DESCRIPTION OF EXEMPLARY EMBODIMENTS OF THE PRESENT INVENTION

The following description of exemplary embodiment(s) is merely illustrative in nature and is not intended to limit the invention, its application, or uses.

Laser emitter diode bar arrays provide increased laser power but the emission from multiple spatially-separated emitters creates challenges for combining the power into a single high-power shaped beam. The combining of multiple shaped beams into a single far-field shaped beam has many applications, both commercial and military. Exemplary embodiments can combine the multiple emitters of a high-power laser diode bar array to produce at least one collimated, beam pattern (e.g. tophat-shaped, and the like) in the far field.

The short wavelength of laser diodes and the high divergence in the fast axis can make an all-diffractive solution difficult. Either refractives or a combination of refractives and diffractives can be used to collimate the light from a laser diode. With laser diodes moving to longer wavelengths, including the mid-IR wavelengths (3-5 microns), this restriction is mitigated somewhat. The longer wavelength allows proportionately larger feature sizes in the diffractive element, making it easier to fabricate.

Diffractive “diffusers” are a special type of beam shapers which take a collimated input beam and replicate the beam into thousands of angular orders over a narrow solid angle, simulating a “tophat” profile in the far field. A lenslet (e.g. diffractive, refractive, and the like) diffuser producing the tophat profile can be iteratively designed on a computer until the uniformity meets requirements. A lenslet (e.g. diffractive, refractive, and the like) collimator can be designed with commercial lens design software.

At least one exemplary embodiment can have a surface diffractive element which multiplexes both a lenslet (e.g. diffractive, refractive, and the like) collimator and a diffractive (e.g. diffractive, refractive, and the like) beam shaper into a diffractive element. However, these can be combined to take into account the divergence angles in the fast and slow axis directions and the emitter source sizes. Using a collimator lenslet array can produce an elliptical beam in the far field with a greater divergence in the slow axis direction due to the increased source size. To compensate for this, the diffractive diffuser can be designed to produce an elliptical beam cross-section, so that when combined, the far-field pattern is a circular tophat profile. Exemplary embodiments can combine both slow and fast axis lenslet elements into single and multiple lenslet arrays. The lenslets can be constructed of various materials (e.g. Si, SiN, SiCO2, GaAs, glass, optical plastic and the like). The lenslets can be formed by plasma etching, reflow, molding, and the like.

Further exemplary embodiments can separate the collimation and diffusion functions onto multiple lenticular arrays with separate surfaces.

Additional exemplary embodiments can combine a refractive lenticular collimator with a diffractive lenticular diffuser on one or separate surfaces.

Further exemplary embodiments can use refractive anamorphic lens for the fast axis collimation and a diffractive element for the slow axis collimation.

In at least one exemplary embodiment, the collimation surface can be placed close enough to the diode emitter array, within the region where adjacent beamlets do no overlap. The diffuser portion can be placed in the overlap region or the non-overlap region.

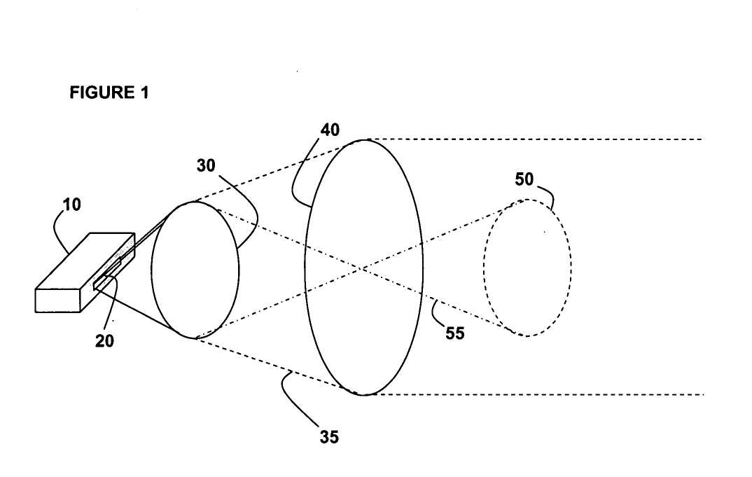

FIG. 1 illustrates at least one exemplary embodiment. A multi-mode laser diode 10 emits light from a light emitting portion 20. The light passes through a lenslet 30 with variable slow and fast properties. The light passing through the lenslet 30 has its fast and slow properties affected such that the light is split along multiple paths, a fast axis light path 55 (refractive path), and a slow axis light path 35 (diffractive path). The combined light paths result in a cross-section (desired beam profile) 50 with variable qualities (e.g. a patterned cross-section, uniform energy distribution, uniform intensity, patterned intensities, tophat, and the like). The pattern can be further varied by passing the combined light through other lenslets some of which can have slow/fast axis properties. The lenslets can be micro-lenses, diffractive elements, refractive elements, and the like. The pattern can be a condensed spot of various sizes and shapes (e.g. 1 mm, sub millimeter, elliptical, circular, and the like) or a dispersed region of intensity. The lenslets can be etched or molded and made of various properties depending upon the light wavelengths. The wavelength of light of the multi-mode laser diode(s) can be visible, infrared, ultraviolet, and the like. Likewise the diode(s) can be multi-wavelength emitting.

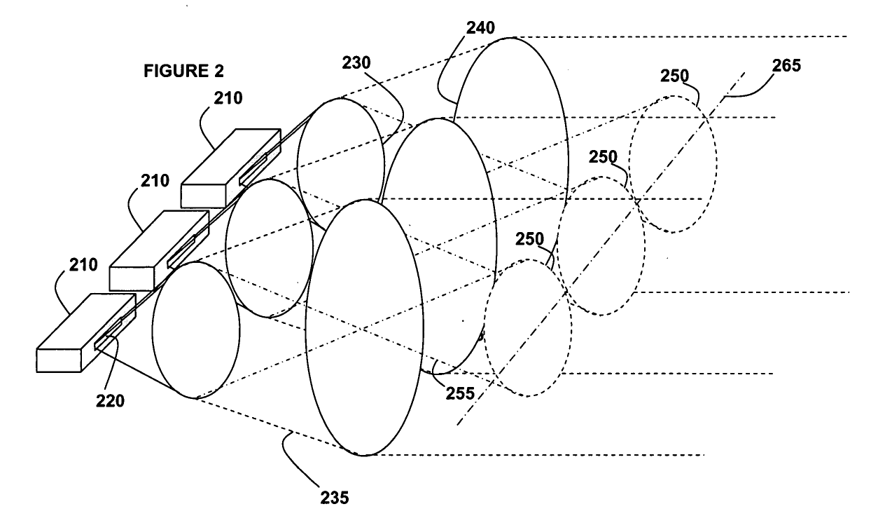

FIG. 2 illustrates at least one exemplary embodiment where the embodiment shown in FIG. 1 is repeated multiple times using multiple multi-mode laser diode emitters 210, which emit light from light emitting portions 220. The light passes through a lenslets 230 with variable slow and fast properties. The light passing through the lenslets 230 has its fast and slow properties affected such that the light is split along multiple paths, a fast axis light path 255 (refractive path), and a slow axis light path 235 (diffractive path). The combined light paths result in a cross-sections 250 (e.g. a patterned cross-section, uniform energy distribution, uniform intensity, patterned intensities, tophat, and the like) with variable qualities along a particular direction, fast axis refractive path, 255. The patterns can be further varied by passing the combined light through other lenslets some of which can have slow/fast axis properties. The direction 255 can vary and can be non-linear.

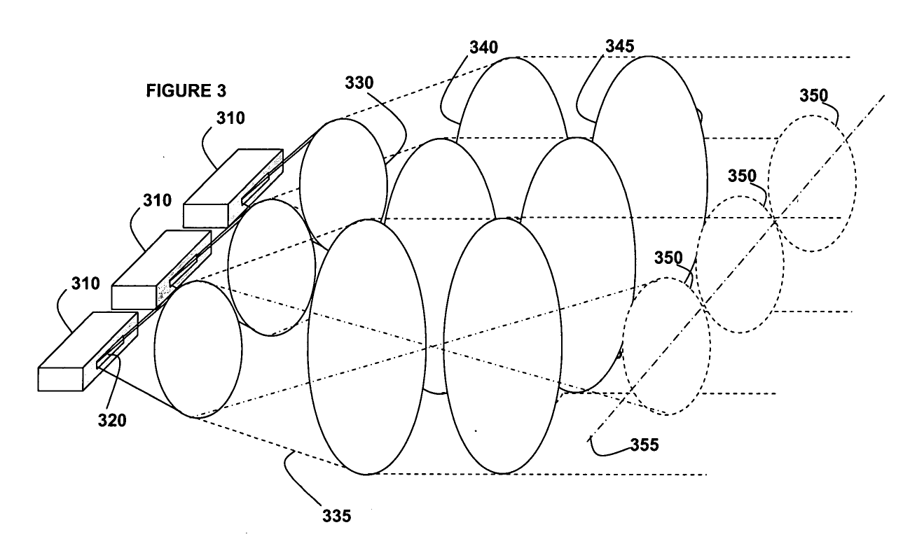

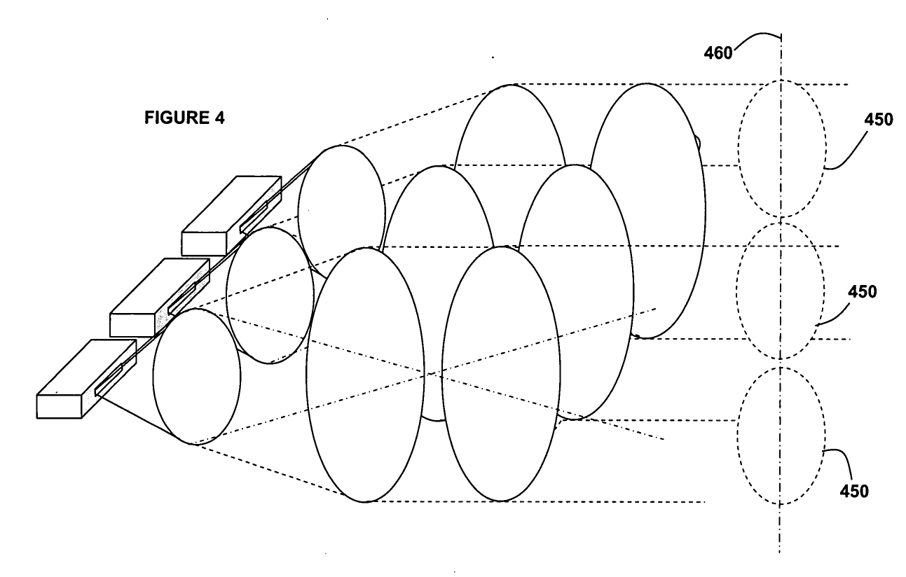

FIG. 3 illustrates at least one exemplary embodiment where the embodiment shown in FIG. 1 is repeated multiple times using multiple multi-mode laser diode emitters 310, which emit light from light emitting portions 320. The light passes through a lenslets 330 with variable slow and fast properties. The light passing through the lenslets 330 has its fast and slow properties affected such that the light is split along multiple paths, a fast axis light path 355 (refractive path), and a slow axis light path 335 (diffractive path). The combined light paths result in cross-sections 350 (e.g. at least one of a patterned cross-section, uniform energy distribution, uniform intensity, patterned intensities, tophat, and the like) with variable qualities along a particular direction 355. A second set of lenslets 345 can be either refractive or diffractive. The first lenslet array 340 and second lenslet array 345 can phase interact to obtain a designed pattern which can lie along a two-dimension direction or a linear one 355. Likewise the lenticular arrays (FIG. 4) can vary properties such that the patterns 450, which can have portions that overlap, result in a different linear orientation 460 or can form a two dimensional pattern.

The foregoing description of the invention is merely exemplary in nature and, thus, variations that do not depart from the gist of the invention are intended to be within the scope of the embodiments of the present invention. Such variations are not to be regarded as a departure from the spirit and scope of the present invention.

What is claimed is:

1. An optical device comprising:
at least one first lens, having a fast axis different from its slow axis; and
at least one second lens having a fast axis different from its slow axis, where the second lens is arranged between the first lens and an initial profile of a light beam, the initial profile of the light beam being transmitted through the first lens and incident on the second lens, a portion of the initial profile of the light beams incident on the second lens being transmitted through the second lens such that the fast and slow axes of both lenses interact to create at least one desired beam profile at a predetermined position, wherein the predetermined position is such that the first and second lenses lie between the initial profile and the predetermined position.

2. The device of claim 1, wherein the beam profile is a uniform energy profile.

3. The device of claim 1, wherein the beam profile is a small intense spot.

4. The device according to claim 3, wherein the spot size is sub millimeter in size.

5. The device according to claim 3, wherein the cross-sectional shape is circular and has a tophat energy profile.

6. The device according to claim 1, wherein the first lens is one of a collimator and a diffractive lenslet.

7. The device according to claim 1, wherein the second lens is one of a collimator and a diffractive lenslet.

8. The device according to claim 1, further comprising a third lens, the third lens having a fast axis different from its slow axis, wherein the third lens positioned between the second lens and the predetermined position.

9. The device according to claim 1, wherein the desired beam profile lies along a one dimensional line.

10. The device according to claim 1, wherein the at least one desired beam profile lies along a two dimensional pattern.

11. The device according to claim 1, wherein the light beam is a laser beam.

12. The device according to claim 11, wherein the laser beam is emitted from a laser diode.

13. A method for shaping a light beam from a light beam source into a desired profile at a predetermined position comprising:
positioning at least one first lens between the light beam source and the desired profile, the first lens having a fast axis different from its slow axis; and
positioning at least one second lens having a fast axis different from its slow axis, where the second lens is arranged between the first lens and the predetermined position, the light being transmitted through the first lens and incident on the second lens, a portion of the light incident on the second lens being transmitted through the second lens such that the fast and slow axes of both lenses interact to create the desired profile at the predetermined position, wherein the predetermined position is such that the first and second lenses lie between the laser diode and the predetermined position.

14. The method of claim 13, wherein the beam profile is a uniform energy profile.

15. The method of claim 13, wherein the beam profile is a small intense spot.

16. The method according to claim 13, wherein the spot size is sub millimeter in size.

17. The method according to claim 13, wherein the cross-sectional shape is circular and has a tophat energy profile.

18. The method according to claim 13, wherein the first lens is one of a collimator and a diffractive lenslet.

19. The method according to claim 13, wherein the second lens is one of a collimator and a diffractive lenslet.

20. The method according to claim 13, further comprising a third lens, the third lens having a fast axis different from its slow axis, the third lens positioned between the second lens and the desired beam profile.

21. The method according to claim 13, wherein the desired beam profile lies along a one dimensional line.

22. The method according to claim 13, wherein the desired beam profile lies along a two dimensional pattern.

23. The method according to claim 13, wherein the light beam is a laser beam.

24. The method according to claim 13, wherein the laser beam is emitted from a laser diode.
